(19) United States
(12) Patent Application Publication
(10) Pub. No.: US 2024/0232141 A1
(43) Pub. Date: Jul. 11, 2024

(54) VERSION AGNOSTIC APPLICATION PROGRAMMING INTERFACE FOR VERSIONED FILED SYSTEMS

(71) Applicant: VMware LLC, Palo Alto, CA (US)

(72) Inventors: David DILLON, Boston, MA (US); Kostadin GEORGIEV, Sofia (BG)

(21) Appl. No.: 18/151,001

(22) Filed: Jan. 6, 2023

(51) Int. Cl. G06F 16/18

(52) U.S. Cl. CPC G06F 16/1873

(57) ABSTRACT

The disclosure provides an approach for a version agnostic application programming interface (API) for versioned file systems. A method of processing a read request in a versioned file system includes receiving a write request from a first client. The write request adds one or more files to a first set of files in a first version of a directory or removes one or more files from the set of files in the first version of the directory. The method includes generating a second version of the directory containing a second set of files comprising the first set of files after adding or removing the one or more files. The method includes receiving a read request from a second client for a file, where the file is not in the second set of files, and where the read request does not specify a file version. The method includes serving the read request from an earlier version of the directory than the second version of the directory.

### BACKGROUND

Computer virtualization is a technique that involves encapsulating a physical computing machine platform into virtual machine(s) (VM(s) executing under control of virtualization software on a hardware computing platform or “host” A VM provides virtual hardware abstractions for processor, memory, storage, and the like to a guest operating system (OS). The virtualization software, also referred to as a “hypervisor,” may include one or more virtual machine monitors (VMMs) to provide execution environment(s) for the VM(s).

Software defined networking (SDN) involves a plurality of physical hosts in communication over a physical network infrastructure of a data center (e.g., an on-premise data center or a cloud data center). The physical network to which the plurality of physical hosts are connected may be referred to as an underlay network. Each host has one or more virtualized endpoints such as VMs, containers, Docker containers, data compute nodes, isolated user space instances, namespace containers, or other virtual computing instances (VCIs). The VMs running on the hosts may communicate with each other using an overlay network established by hosts using a tunneling protocol. Though certain aspects are discussed herein with respect to VMs, it should be noted that the techniques may apply to other suitable VCIs as well.

An SDN data center may implement a versioned file system. A versioned file system is a computer file system that allows a computer file to exist in several versions at the same time. A versioned file system provides a form of revision control by keeping a number of old versions of a file. Some versioned file systems limit the number of changes per minute or per hour or take periodic snapshots to avoid storing large numbers of file versions with trivial changes.

A versioned file system may be similar to a periodic backup and journaling file systems with some differences. While backups may be triggered on a timed basis, versioning may occur when the file changes. Also, backups may be system-wide or partition-wide, while versioning may occur independently on a file-by-file basis. Further, backups may be written to separate media, while versioning file systems may write to the same hard drive (e.g., to the same folder, directory, or local partition). While journaling file systems may work by keeping a log of the changes made to a file before committing those changes to that file system and overwriting the prior version, a versioned file system may keep previous copies of a file when saving new changes.

With a versioned file system, clients can look at a single version of the file system and not have to accommodate for concurrent modification from other clients as they operate over periods of time. However, naïve clients in the system are unaware of the file versions. For these clients, the versioned file system may provide a default view of the files. For example, the versioned file system may provide the latest version or some other arbitrary version. The view can change over time as other clients perform updates. These version unaware clients may then try to perform operations that span multiple versions of the file system. Some files may no longer exist, resulting in error.

In one illustrative example, errors may occur after compaction in large scale databases. Many small files in a database may increase latency of fulfilling queries to the database. Compaction is a process which takes smaller files in a directory and replaces them with a smaller set of more efficient files. Compaction allows the benefit of writing of many small files and also the benefits of reading larger files. In a versioned file system, compaction can operate within a single transaction, allowing the change to seamlessly happen in the background. The compacted files may be rewritten to a new version of the directory, while the system still maintains the old version of the directory. Version aware clients can choose a consistent version of the file system that may be before or after compaction, and use that version throughout an operation. These clients may list files in a directory and sequentially process the files over time regardless of another process like compaction removing any of the files. If a version unaware client attempts to do the same, compaction may run in the middle of the operation and a file the version unaware client expects to read next may no longer exist.

Thus, all clients may need to be version aware or the system may need additional complexity for external coordination between clients (e.g., using locking) to assure consistency during operations. Some systems do not use versioned file systems and, instead, implement versioning at the application layer. The system may store a consistent set of files as data in a file, instead of organizing by directory in the file system. The system keeps all files, old versions and new versions, on disk until a cleaning action is performed. These approaches involve changing the client logic to become aware of the solution.

Accordingly, techniques are needed for versioned file systems that support version unaware clients.

It should be noted that the information included in the Background section herein is simply meant to provide a reference for the discussion of certain embodiments in the Detailed Description. None of the information included in this Background should be considered as an admission of prior art.

### SUMMARY

The technology described herein provides a method for processing a read request in a versioned file system. The method generally includes receiving a write request from a first client. The write request adds one or more files to a first set of files in a first version of a directory or removes one or more files from the set of files in the first version of the directory. The method includes generating a second version of the directory containing a second set of files comprising the first set of files after adding or removing the one or more files. The method includes receiving a read request from a second client for a file, where the file is not in the second set of files, and where the read request does not specify a file version. The method includes serving the read request from an earlier version of the directory than the second version of the directory.

Further embodiments include a non-transitory computer-readable storage medium storing instructions that, when executed by a computer system, cause the computer system to perform the method set forth above, and a computer system including at least one processor and memory configured to carry out the method set forth above.

### BRIEF DESCRIPTION OF THE DRAWINGS

FIG. 1 depicts a block diagram of an example data center with a version agnostic application programming interference (API) for a versioned file system, according to one or more embodiments.

FIG. 2 depicts a file error during an operation by a version unaware client in a versioned file system.

FIG. 3 depicts a successful operation by the version unaware client in the versioned file system with the version agnostic API, according to one or more embodiments.

FIG. 4 depicts a flow diagram illustrating example operations for a version agnostic API for a versioned file system, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for a version agnostic API for versioned file systems. The version agnostic API allows seamless support for legacy, version unaware clients, without modification of the clients, while still allowing for a versioned file system to add, modify, or delete filed atomically within a transaction. The version agnostic API allows operations like compaction to be performed within a transaction in the versioned file system without errors. Clients can then choose a version of the file system and use that version across an operation to assure consistency.

In certain embodiments, when a version unaware client queries the versioned file system, the version agnostic API searches over all recent versions of the file system. If a file has existed in the recent past, a call to the API will return the file. For example, instead of checking only the latest version (or some other arbitrary version) of a directory for a file, the version agnostic API searches all versions of the directory for the file (or some amount of recent directory versions). In some embodiments, the version agnostic API first checks the latest version of the directory and, if the file is not found, then checks the next latest version of the directory, and so on. In an example, the version agnostic API continues checking successive versions of the directory for the file in this manner until a condition is met, such as reaching a threshold number of versions, a threshold amount of time, or the like. In some embodiments, the version agnostic API returns the latest version of the file that is found.

The version agnostic API avoids the needs of changing the client implementation or for external coordination and pushes the logic and complexity down into the file system. Version unaware clients can see files consistently, without specifying a file version or being aware the file system is versioned. Version aware clients can still perform operations atomically within a transaction so any client will always see the directories in a valid state. Version unaware clients will still be able to read data as expected because they will always receive a valid view of the directory and be able to retrieve any files inside.

It should be understood that while aspects of the present disclosure are described with respect to a versioned file system implemented in a virtual data center, the version agnostic API may be used in any versioned file system.

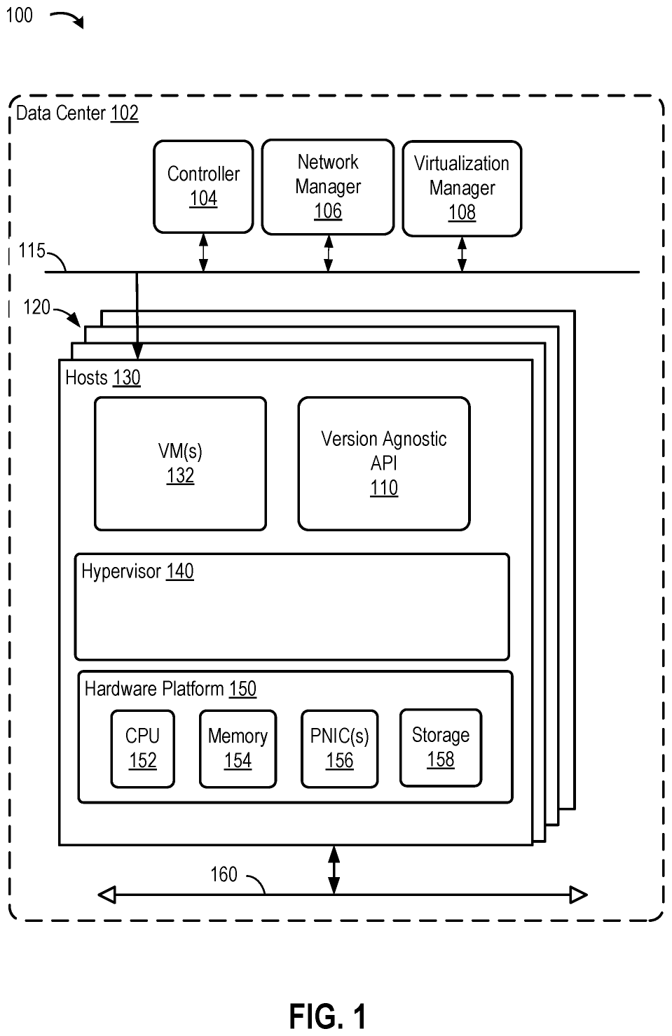

FIG. 1 depicts example physical and virtual network components in a networking environment 100 in which embodiments of the present disclosure may be implemented.

Networking environment 100 includes a data center 102. Data center 102 includes one or more hosts 130, a management network 115, a data network 160, a controller 104, a network manager 106, and a virtualization manager 108. Data network 160 and management network 115 may be implemented as separate physical networks or as separate virtual local area networks (VLANs) on the same physical network.

Data center 102 includes one or more clusters of hosts 130. Hosts 130 may be communicatively connected to data network 160 and management network 115. Data network 160 and management network 115 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 130 may be geographically co-located servers on the same rack or on different racks in any arbitrary location in the data center. Host(s) 130 are configured to provide a virtualization layer, also referred to as a hypervisor 140, that abstracts processor, memory, storage, and networking resources of a hardware platform 150 into multiple VMs.

Host(s) 130 may be constructed on a server grade hardware platform 150, such as an x86 architecture platform. Hardware platform 150 of a host 130 may include components of a computing device such as one or more processors (CPUs) 152, memory 154, one or more network interfaces (e.g., PNICs 156), storage 158, and other components (not shown). A CPU 152 is configured to execute instructions, for example, executable instructions that perform one or more operations described herein and that may be stored in memory 154 and storage 158. PNICs 156 enable host 130 to communicate with other devices via a physical network, such as management network 115 and data network 160. In some embodiments, hosts 130 access a shared storage using PNICs 156. In another embodiment, each host 130 contains a host bus adapter (HBA) through which input/output operations (IOs) are sent to the shared storage (e.g., over a fibre channel (FC) network). A shared storage may include one or more storage arrays, such as a storage area network (SAN), network attached storage (NAS), or the like. The shared storage may comprise magnetic disks, solid-state disks, flash memory, and the like as well as combinations thereof. In some embodiments, the storage 158 (e.g., hard disk drives, solid-state drives, etc.) of host 130 can be aggregated and provisioned as part of a virtual SAN, which is another form of shared storage.

Hypervisor 140 architecture may vary. Virtualization software can be installed as system level software directly on the server hardware (often referred to as “bare metal” installation) and be conceptually interposed between the physical hardware and the guest operating systems executing in the virtual machines. Alternatively, the virtualization software may conceptually run “on top of” a conventional host operating system in the server. In some implementations, hypervisor 140 may comprise system level software as well as a “Domain 0” or “Root Partition” VM (not shown) which is a privileged machine that has access to the physical hardware resources of the host 130. In this implementation, one or more of a virtual switch, virtual router, virtual tunnel endpoint (VTEP), etc., along with hardware drivers, may reside in the privileged VM. One example of hypervisor 140 that may be configured and used in embodiments described herein is a VMware ESXI™ hypervisor provided as part of the VMware vSphere® solution made commercially available by VMware, Inc. of Palo Alto, CA.

Data center 102 includes a management plane and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 106 at least in part implements the management plane and controller 104 at least in part implements the control plane

The control plane determines the logical overlay network topology and maintains information about network entities such as logical switches, logical routers, and endpoints, etc. The logical topology information is translated by the control plane into network configuration data that is then communicated to network elements of host(s) 130. Controller 104 generally represents a control plane that manages configuration of VMs within data center 102. Controller 104 may be one of multiple controllers executing on various hosts 130 in data center 102 that together implement the functions of the control plane in a distributed manner. Controller 104 may be a computer program that resides and executes in a server in data center 102, external to data center 102 (e.g., such as in a public cloud), or, alternatively, controller 104 may run as a virtual appliance (e.g., a VM) in one of hosts 130. Although shown as a single unit, it should be understood that controller 104 may be implemented as a distributed or clustered system. That is, controller 104 may include multiple servers or virtual computing instances that implement controller functions. It is also possible for controller 104 and network manager 106 to be combined into a single controller/manager. Controller 104 collects and distributes information about the network from and to endpoints in the network. Controller 104 is associated with one or more virtual and/or physical CPUs (not shown). Processor(s) resources allotted or assigned to controller 104 may be unique to controller 104, or may be shared with other components of data center 102. Controller 104 communicates with hosts 130 via management network 115, such as through control plane protocols. In some embodiments, controller 104 implements a central control plane (CCP).

Network manager 106 and virtualization manager 108 generally represent components of a management plane comprising one or more computing devices responsible for receiving logical network configuration inputs, such as from a user or network administrator, defining one or more endpoints (e.g., VCIs) and the connections between the endpoints, as well as rules governing communications between various endpoints.

In some embodiments, virtualization manager 108 is a computer program that executes in a server in data center 102 (e.g., the same or a different server than the server on which network manager 106 executes), or alternatively, virtualization manager 108 runs in one of the VMs. Virtualization manager 108 is configured to carry out administrative tasks for data center 102, including managing hosts 130, managing VMs running within each host 130, provisioning VMs, transferring VMs from one host 130 to another host, transferring VMs between data centers, transferring application instances between VMs or between hosts 130, and load balancing among hosts 130 within data center 102. Virtualization manager 108 takes commands as to creation, migration, and deletion decisions of VMs and application instances on data center 102. However, virtualization manager 108 also makes independent decisions on management of local VMs and application instances, such as placement of VMs and application instances between hosts 130. In some embodiments, virtualization manager 108 also includes a migration component that performs migration of VMs between hosts 130, such as by live migration.

In some embodiments, network manager 106 is a computer program that executes in a server in networking environment 100, or alternatively, network manager 106 may run in a VM, e.g., in one of hosts 130. Network manager 106 communicates with host(s) 130 via management network 115. Network manager 106 may receive network configuration input from a user or an administrator and generates desired state data that specifies how a logical network should be implemented in the physical infrastructure of data center 102. Network manager 106 is configured to receive inputs from an administrator or other entity, e.g., via a web interface or application programming interface (API), and carry out administrative tasks for data center 102, including centralized network management and providing an aggregated system view for a user. One example of network manager 106 that can be configured and used in embodiments described herein as network manager 106 is a VMware NSX® platform made commercially available by VMware, Inc. of Palo Alto, CA.

VMs 132 deployed onto host cluster 120 can include containerized applications and executing in pod VMs and native VMs, and/or applications executing directly on guest OSs (non-containerized) (e.g., executing in native VMs).

Data center 102 may run a versioned file system. Clients (e.g., VMs 132 and other components) can write files into a directory. In some embodiments, the data in the files become part of a table forming a database that can be queried by clients for the data. The versioned file system may provide an explicit history of each file. Any write to a file may create a new version as a descendent of the file it is based on, for example, rather than simply overwriting changes. In some embodiments, a file system agent within the data path between a local file system and storage. The file system agent sees read and write events from the local file system. Any time a file is opened, the version of the file to open may be explicitly specified. The name of the file may be appended with an updated version number.

In some embodiments, the versioned file system comprises a set of unstructured data or a set of structured data representations. In some embodiments, the versioned file system includes a root element, a root directory, and zero or more elements associated with the root directory. Alternatively, in some embodiments, the versioned file system comprises a set individually versioned directories. Each directory may contain zero or more subdirectories and zero or more files. Upon a change (e.g., file creation, file deletion, file modification, directory creation, directory deletion, or directory modification), an interface between the file system and a data store may create and export a new version of the file and directory. The new version may differ from the first version up to and including the root element of the new version. Thus, the new version differs from the first version in one or more (but not necessarily all) parent elements with respect to the element in which the change within the file system occurred.

The data store may be any type of storage device (e.g., memory 154 and/or storage 158), system or architecture, such as a cloud storage service providers. In some embodiments, the data representations are transported between file system and the data store via Representational State Transfer (REST) protocol, Simple Object Access Protocol (SOAP), Hypertext Transfer Protocol (HTTP), or a combination of protocols. In some example embodiments, a versioned file system may be implemented in a virtual storage area network (VSAN). In some example embodiments, a structured data representation uses a B+ tree data structure or a copy-on-write B+ tree structure. In some objects, the versioned file system is an object storage system.

In an illustrative example of a Linux file system, directories may include/bin (containing binary files), /boot (containing files for starting the system), /dev (containing variable file contents), /etc (containing system-wide configuration files), /home (containing user files and subdirectories), /lib (containing library files), /media (containing external storage files mounted when connected), /mnt, /opt (containing built software files), /proc (containing files with information about the computer, such as CPU and kernel), /root (an administrator home directory containing variable file contents), /run (containing temporary data files for system processes), /sbin (containing administrator files), /usr (containing various file contents and subdirectories related to applications and services), /srv (containing server files), /sys (containing files from connected devices), /tmp (containing temporary files), and/var (containing variable file contents).

In certain embodiments, data center 102 may include version agnostic API 110 for a versioned file system. In some embodiments, the version agnostic API 110 runs on hosts 130. The API allows clients to access the versioned file system.

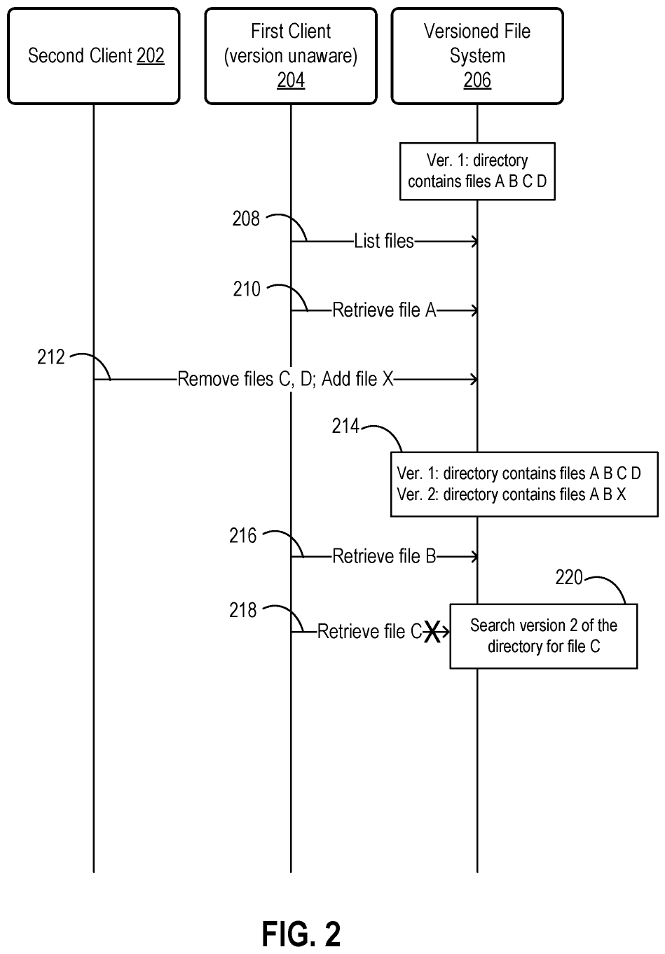

As discussed herein, without the version agnostic API 110, errors may occur in a versioned file system during operations by version unaware clients. FIG. 2 depicts a file error during an operation by a version unaware first client 204 in a versioned file system 206.

In some embodiments, first client 204 and second client 202 may be hosts (e.g., host 130), VMs (e.g., a VM 132) or other VCIs, applications, or other entities (e.g., in data center 102) that access versioned file system 206.

Versioned file system 206 may be any type of versioned file system. In some embodiments, versioned file system 206 is a structured or unstructured file system. As shown, at some point, versioned file system 206 maintains a directory version containing files, shown in FIG. 2 as files A, B, C, and D.

In some embodiments first client 204 and second client 202 access the versioned file system via read and write requests, e.g., using input/output (I/O) commands or other protocols.

As shown in FIG. 2, first client 204 is a version unaware client. Accordingly, first client 204 may not be aware that the file system is a versioned file system. When first client 204 accesses versioned file system 206, first client 204 does not specify any version. As shown in FIG. 2, at step 208, first client 204 may check the directory and see the files A, B, C, and D. First client 204 may initiate some operation, such as compaction. During the operation, first client 204 may access the versioned file system 206 one or more times. However, because first client 204 is version unaware, first client 204 may not be aware that another client has modified the directory, such as by changing, adding, or removing one or more of the files in the directory, which can lead to an error.

In the illustrated example shown in FIG. 2, at step 210, first client 204 successfully retrieves the file A from the versioned file system. Second client 202 may then access the versioned file system 206, at step 212, to remove the files C and D and add the file X, for example, as part of compaction. Accordingly, at step 214, a second version of the directory is created in the versioned file system 206 containing the file A, B, and X (while still maintaining the earlier version 1 of the directory). Because first client 204 is version unaware, when the first client 204 accesses the directory, the versioned file system 206 will return the latest version of the directory. Thus, at step 216, when first client 204 attempts to retrieve the file B from the directory, the file B may be successfully returned because file B is still contained in the version 2 of the directory, however, when the first client 204 attempts to retrieve the file C from the directory, at step 218, an error occurs because file C does not exist in the version 2 of the directory in the versioned file system 206 when the version 2 of the directory is searched at step 220.

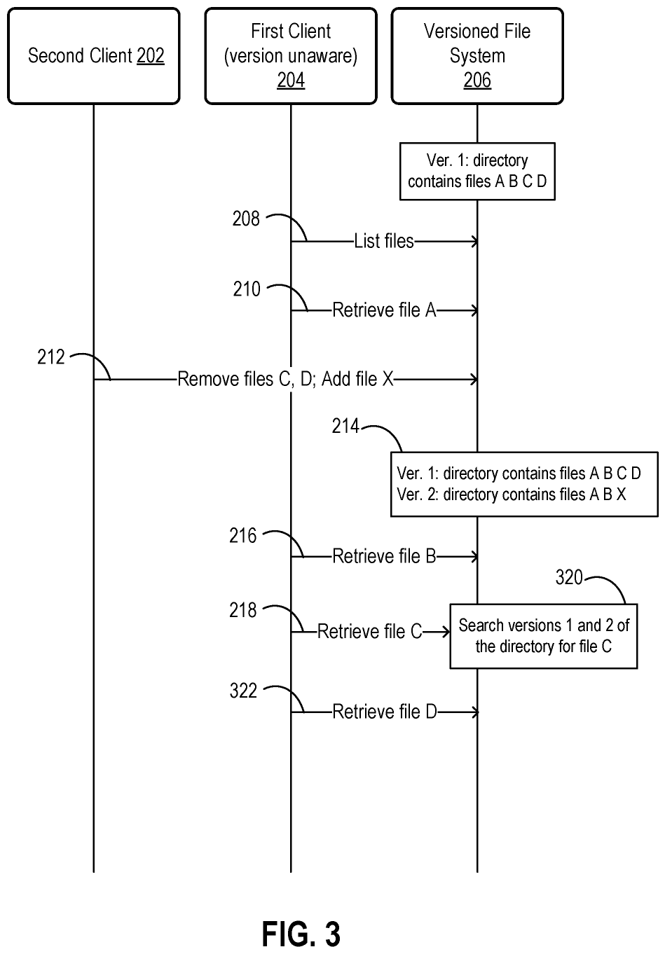

FIG. 3 depicts a successful operation by the version unaware client in the versioned file system with the version agnostic API, according to one or more embodiments. As shown in FIG. 3, even after the directory is changed and the new version of the directory is created, at step 214, the version unaware first client 204 can successfully retrieve the file C from the versioned file system 206 at step 218. For example, at step 320, the version agnostic API searches both the version 1 and the version 2 of the directories. Accordingly, although the version agnostic API does not find the file C in the version 2 of the directory, the version agnostic API does find the file C in the version 1 of the directory and returns file C from the version 1 of the directory because that is the latest version of the file C. As shown, the version unaware first client 204 can successfully retrieve the file D (or any of the files A, B, C, D, or X) from the versioned file system 206 at step 320.

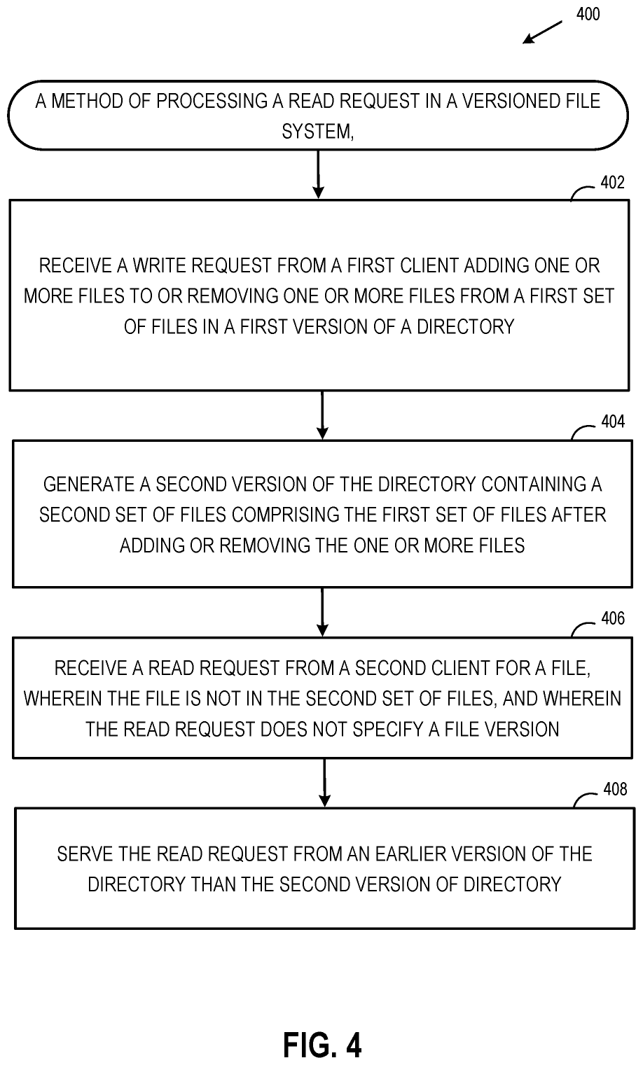

FIG. 4 depicts an example call flow illustrating operations 400 for processing a read request in a versioned file system (e.g., such as the versioned file system 206), according to one or more embodiments. Operations 400 may be performed by a versioned file system using a version agnostic API (e.g., such as the version agnostic API 110).

Operations 400 may begin, at operation 402, by receiving a write request (e.g., step 212 in FIG. 3) from a first client (e.g., second client 202), wherein the write request adds one or more files (e.g., file X in FIG. 3) to a first set of files (e.g., files A, B, C, and D of the directory in FIG. 3) in a first version of a directory (e.g., version 1 of the directory in FIG. 3) or removes one or more files (e.g., files C and D of the directory in FIG. 3) from the set of files in the first version of the directory.

Operations 400 may include, at operation 404, generating a second version of the directory (e.g., version 2 of the directory in FIG. 3) containing a second set of files (e.g., files A, B, and X of the directory in FIG. 3) comprising the first set of files after adding or removing the one or more files.

Operations 400 may include, at operation 406, receiving a read request (e.g., at step 218 in FIG. 3) from a second client (e.g., first client 204) for a file (e.g., file C in FIG. 3), wherein the file is not in the second set of files, and wherein the read request does not specify a file version.

Operations 400 may include, at operation 408, serving the read request from an earlier version of the directory (e.g., from version 1 of the directory in FIG. 3) than the second version of the directory.

In some embodiments, the second client a version unaware client.

In some embodiments, the second client comprises a virtual machine (e.g., a VM 132), a virtual computing instance, or an application in a virtual network (e.g., data center 102).

In some embodiments, the second version of the directory comprises a most recent version of the directory, and the earlier version of the directory comprises a latest version of the directory that contains the file.

In some embodiments, the read request is served via an application programming interface (API).

In some embodiments, operations 400 further include searching a most recent version of the directory for the file in response to receiving the read request; searching a next most recent of the directory in response to determining the file is not found; and serving the read request once the file is found in a version of the directory.

In some embodiments, the write request from the first client is sent as part of a compaction operation on the directory.

The embodiments described herein provide a technical solution to a technical problem associated with support version unaware clients in versioned file systems. More specifically, implementing the embodiments herein allows for a version agnostic API for a versioned file system. The version agnostic API may allow version aware and version unaware clients to use a versioned file system without errors in accesses to the versioned file system. For example, a version unaware client is able to perform a read to a file even during an operation, such as compaction, where another client has modified (e.g., removed) the file.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of processing a read request to a versioned file system, the method comprising:
receiving a write request from a first client, wherein the write request adds one or more files to a first set of files in a first version of a directory or removes one or more files from the first set of files in the first version of the directory;
generating a second version of the directory containing a second set of files comprising the first set of files after adding or removing the one or more files;
receiving a read request from a second client for a file, wherein the file is not in the second set of files, and wherein the read request does not specify a file version; and
serving the read request from an earlier version of the directory than the second version of the directory.

2. The method of claim 1, wherein the second client is a version unaware client.

3. The method of claim 1, wherein the second client comprises a virtual machine, a virtual computing instance, or an application in a virtual network.

4. The method of claim 1, wherein the second version of the directory comprises a most recent version of the directory, and wherein the earlier version of the directory comprises a latest version of the directory that contains the file.

5. The method of claim 1, wherein the read request is served via an application programming interface (API).

6. The method of claim 1, further comprising, searching multiple version of the directory for the file in response to receiving the read request.

7. The method of claim 1, further comprising:
searching a most recent version of the directory for the file in response to receiving the read request;
searching a next most recent version of the directory in response to determining the file is not found in the most recent version of the directory; and
serving the read request once the file is found in a version of the directory.

8. The method of claim 1, wherein the write request from the first client is sent as part of a compaction operation on the directory.

9. A system comprising:
at least one memory; and
one or more processors coupled to the memory and configured to:
receive a write request from a first client, wherein the write request adds one or more files to a first set of files in a first version of a directory or removes one or more files from the first set of files in the first version of the directory;
generate a second version of the directory containing a second set of files comprising the first set of files after adding or removing the one or more files;
receive a read request from a second client for a file, wherein the file is not in the second set of files, and wherein the read request does not specify a file version; and
serve the read request from an earlier version of the directory than the second version of the directory.

10. The system of claim 9, wherein the second client is a version unaware client.

11. The system of claim 9, wherein the second client comprises a virtual machine, a virtual computing instance, or an application in a virtual network.

12. The system of claim 9, wherein the second version of the directory comprises a most recent version of the directory, and wherein the earlier version of the directory comprises a latest version of the directory that contains the file.

13. The system of claim 9, wherein the read request is served via an application programming interface (API).

14. The system of claim 9, wherein the one or more processors are configured to search multiple version of the directory for the file in response to receiving the read request.

15. The system of claim 9, wherein the one or more processors are configured to:
search a most recent version of the directory for the file in response to receiving the read request;
search a next most recent version of the directory in response to determining the file is not found in the most recent version of the directory; and
serve the read request once the file is found in a version of the directory.

16. The system of claim 9, wherein the write request from the first client is sent as part of a compaction operation on the directory.

17. A non-transitory computer-readable medium comprising instructions that, when executed by one or more processors of a computing system, cause the computing system to perform operations for processing a read request to a versioned file system, the operations comprising:
receiving a write request from a first client, wherein the write request adds one or more files to a first set of files in a first version of a directory or removes one or more files from the first set of files in the first version of the directory;
generating a second version of the directory containing a second set of files comprising the first set of files after adding or removing the one or more files;
receiving a read request from a second client for a file, wherein the file is not in the second set of files, and wherein the read request does not specify a file version; and
serving the read request from an earlier version of the directory than the second version of the directory.

18. The non-transitory computer-readable medium of claim 17, wherein the second client is a version unaware client.

19. The non-transitory computer-readable medium of claim 17, wherein the second version of the directory comprises a most recent version of the directory, and wherein the earlier version of the directory comprises a latest version of the directory that contains the file.

20. The non-transitory computer-readable medium of claim 17, wherein the read request is served via an application programming interface (API).
